(19) United States
(12) Patent Application Publication
(10) Pub. No.: US 2015/0274919 A1
(43) Pub. Date: Oct. 1, 2015

(54) METHOD FOR PRODUCING A FOAM ELEMENT AND PORTABLE FOAM EXTRUDER

(71) Applicant: SIKA TECHNOLOGY AG, Baar (CH)

(72) Inventors: Herbert Ackermann, Tann (CH); Jeannette Clifford, Bremgarten (CH); Frank Hoefflin, Baden (CH)

(21) Appl. No.: 14/435,571

(22) PCT Filed: Sep. 30, 2013
(86) PCT No.: PCT/EP2013/070313

§ 371 Date: Apr. 14, 2015

(30) Foreign Application Priority Data
Oct. 15, 2012 (EP) 12188546.1

(51) Int. Cl. C08J 9/228

(52) U.S. Cl. CPC C08J 9/228

(57) ABSTRACT

Method for producing a foam element, wherein an expandable starting material of the foam material is supplied to a portable extruder (10) in the form of granules (11), is activated or fused therein under pressure and the effect of heat and is expanded to a foam element during the manually controlled discharge from the extruder.

### TECHNICAL FIELD

The invention concerns a method for producing a foam element, a portable foam extruder for carrying out this method as well as the use of a portable extruder for producing foam.

### PRIOR ART

In the various fields of technology, insulation—both thermal insulation and acoustic insulation—of joints, hollow spaces or hollow elements with foams has been known for a long time. In principle, it is possible here, depending on the geometric configuration of the area to be insulated and the processing properties of the materials used, to insert the foam as a separate prefabricated part in the hollow space or hollow element, or to introduce it in a nonexpanded starting state at the site of application and to expand, in particular to foam, it there. For many applications of practical significance, the on-site production of an insulating foam element (in particular of an elongate profile element) directly at the site of use is desirable.

Compact hand-held extrusion devices (hereafter referred to as “portable extruders”) for plastic welding and for applying melt adhesives are known and commercially available; it is also known to guide corresponding apparatuses with coordinate-based control on a robot arm; see U.S. Pat. No. 5,358,397 or DE 10 2009 015 253 A1, for example.

### DESCRIPTION OF THE INVENTION

The object of the invention, therefore, is to provide a method for producing a foam element, which is particularly flexible from the user's point of view. Moreover, a device for implementing this method is to be provided.

This object is achieved, in its process aspect, by a method having the features of Claim 1 and a use of a portable extruder having the features of Claim 16, as well as, in its device aspect, by a portable extruder having the features of Claim 10. Advantageous variants of the inventive concept are the subject matter of the respective dependent claims.

The invention involves the concept of carrying out an activation or a melting of the starting material of the insulation material in a hand-held device used for applying same, and, on the other hand, of designing this device so that the activated starting material expands immediately at its outlet to the desired spatial shape. The energy input into the material, which is required for this purpose, occurs by a pressure increase relative to atmospheric pressure and/or by heating above ambient temperature, wherein the specific parameters are selected as a function of the respective chemical or physical propellants. The energy input can be provided, depending on the material, primarily by thermal methods or primarily by mechanical methods or by a combination of the two methods. According to the invention, it is provided to feed a solid starting material in granule form to the portable extruder. Solid, granular starting material can be manufactured easily and cost effectively, stored, and processed with little waste, thus offering considerable advantages compared to liquid or pasty formulations.

The use of a portable apparatus makes diverse applications possible, including in the field of building construction and civil engineering, and in road construction, as well as in car manufacturing, aircraft manufacturing and shipbuilding, and especially in the case of repair and restoration work of a great variety of types. The foam element formed can be used for filling in holes, recesses, gaps, openings or cracks, and the material can be formulated in such a way that it is suitable for sealing, insulating, structurally reinforcing and/or bonding. It is particularly advantageous that, due to the energy input that already takes place in the portable apparatus, a subsequent thermal process can as a rule be dispensed with.

As additional advantages of the proposed method, the following is noted:

The material can be successfully applied locally in the desired spatial shape (as a foam element), for example, at a construction site or in a plant, and in a flexible manner, without requiring for that purpose prefabricated molds, expensive machines or hazardous fluids. Thus, even small numbers of pieces can be produced economically and many different sites of use can be supplied cost effectively. Seals, insulations, structural reinforcements, etc., with different material compositions and geometric configurations are easily produced using one and the same apparatus, that is to say, with minimal equipment requirements.

The reactants can be successfully stored in the form of separate pellets for a long storage time and, when needed, mixed directly in the extruder and reacted. Thus, granules can be mixed together individually for customers and their specifications, even in small quantities, in a modular system in order to achieve client-specific product properties.

It is possible to successfully insulate, seal and/or produce structural added parts, on site and immediately (i.e., without extended preliminary setup or installation times).

The foam element formed according to the invention already has so-called “green strength,” that is to say, sufficient mechanical properties for subsequent process steps of the insulation, sealing or reinforcement methods, without having to observe waiting times or to carry out a secondary thermal step.

The logistics is simplified for both the supplier of the starting material and for the user, since only pourable materials (granules), and no intermediate products in a multitude of preliminary forms, need to be stored. The possibility of putting together desired material mixtures in modular form, and thus also the possibility of providing them in small amounts, offer additional flexibility and open new market segments for the supplier.

In one embodiment of the invention, it is provided that a portable extruder for producing foams having at least one conveyor screw is used, and that the portable extruder is configured in such a manner, and the mechanical properties of the starting material are predetermined in such a manner, that high pressures and/or shearing forces occur, which at least contribute to a thermal activation of the starting material. In general, according to a preferred aspect of the method according to the invention, high pressures and/or high shearing forces are applied to the expanding starting material, in order to achieve or at least promote an optimized thermal activation of the starting material. In this design it is possible (after an initial preheating) to make do without additional heating under some circumstances and to work in a particularly energy saving way. In another design, a portable extruder having a heating device is used, and the heating device is operated in such a manner that it at least contributes to a thermal activation of the starting material. It is also possible to combine the two methods for activating the starting material.

In another embodiment of the invention, the expansion process of the starting material at the time of the discharge from the portable extruder is controlled by a special nozzle geometry, in particular by an added part attached at the outlet side. Nozzle geometries that are application-adapted and tailored to the specific insulation material (or its starting material) allow a precise control of the expansion process, and the implementation as an added part for the spraying device itself allows the provision of different appropriate nozzle geometries and the rapid and cost effective change in the case of production conversions, whether as a result of use of another insulation material or other profile geometries, etc.

In one specific design, as a result of the nozzle geometry, first a gradual reduction in cross-section with a small gradient over a large length is achieved, then the cross section is (optionally) kept constant over a small length, and then a gradual narrowing of the cross-section with a large gradient over a small length is achieved. This division of the nozzle into sections is an advantageous implementation from the current perspective; however, it should be pointed out that all the aforementioned sections having the respective associated geometric characteristics do not have to be present.

In another embodiment of the invention, it is provided that the starting material passes through several temperature zones, especially a first zone at a relatively lower temperature, in order to prevent bonding and/or premature expansion, and then through a second zone at a higher temperature for the activation or the melting of the material. Finally, the nozzle section is again relatively cool or the temperature remains constant. In another embodiment, which can be combined with the above-mentioned embodiment, but also implemented independently of a predetermined temperature profile, a sensor-based temperature monitoring of the material in the portable extruder is provided, coupled with automatic readjustment or manual updating.

In another embodiment, pressure monitoring is provided in the outlet area or the area near the outlet of the portable extruder, that is, shortly before the material is discharged from the apparatus. For many material compositions, a high pressure is important for satisfactory foaming, and the pressure monitoring allows for an early evaluation of the expected quality of the foam element formed and, in connection with manual updating or automatic adjustment of process parameters, also for an early influencing of the quality.

Moreover, the device aspects of the invention to a large extent result directly from the above-explained process aspects and are therefore not explained here again in detail. However, the following is noted:

The proposed portable extruder in one advantageous design is formed with an outlet-side nozzle arrangement, which is suitable for the expansion of a preactivated starting material having a high volume expansion gradient. Although, in principle, the expansion of the preactivated starting material can occur beyond the outlet of the extruder—limited, for example, by the walls of a hollow element or a hollow space into which the material expands—, it should be considered reasonable, from the current perspective, to provide means for a control of the expansion step, affecting at least the initial phase, within the extruder or (as already mentioned above) in an added part for same (shaping tool).

According to the above, one embodiment of the portable extruder comprises various means arranged over the conveyance path of the starting material (granules), which are designed for implementing a predetermined temperature profile. An advantageous temperature zone arrangement can comprise, in particular, a heating or cooling device for forming a first zone at lower temperature near the intake area, a heating device for forming a second zone having a higher temperature downstream of the first zone, and optionally, means for forming a third zone again at lower temperature downstream of the second zone.

In other embodiments of the portable extruder, at least one temperature sensor for measuring the temperature of the material in the portable extruder and/or a pressure sensor for measuring the pressure is/are provided at a suitable site of the material flow path near the outlet. In designs of these embodiments, the respective sensor system is associated with a manual setting device or an automatic regulation device for updating the processing temperature—optionally for achieving a predetermined temperature profile along the material flow path—and optionally, other process parameters (such as the screw speed).

On the outlet side of the portable extruder, an appropriately formed shaping tool can be provided for a suitable distribution and/or shaping of the foam element produced.

The invention includes the advantageous use of a portable extruder for producing foams according to the invention. A corresponding portable extruder comprises at least one conveyor screw, the screw geometry of which is configured in accordance with the screw cylinder for generating high shearing forces in a conveyed foam starting material, and/or a heating device for heating the starting material. In other words, the conveyor screw can vary, in particular, with regard to the number and the pitch of its turns and/or with regard to its diameter, and can be adapted optimally to a suitable length and to a suitable diameter of the screw cylinder. The heating device moreover can also have an electric or inductive design.

### BRIEF DESCRIPTION OF THE DRAWING

Moreover, advantages and functional features of the invention result from the following description of exemplary embodiments and aspects, in part with reference to the figures.

FIG. 1 shows a schematic representation for explaining an embodiment of the method according to the invention, in the form of a longitudinal section through a portable foam extruder,

FIGS. 2A and 2B show a cross-sectional representation and top view of an added part of an extruder according to another embodiment of the invention, and

FIGS. 3A and 3B show a representation in longitudinal section and a perspective view of an added part of an extruder according to another embodiment of the invention.

### METHOD OF IMPLEMENTING THE INVENTION

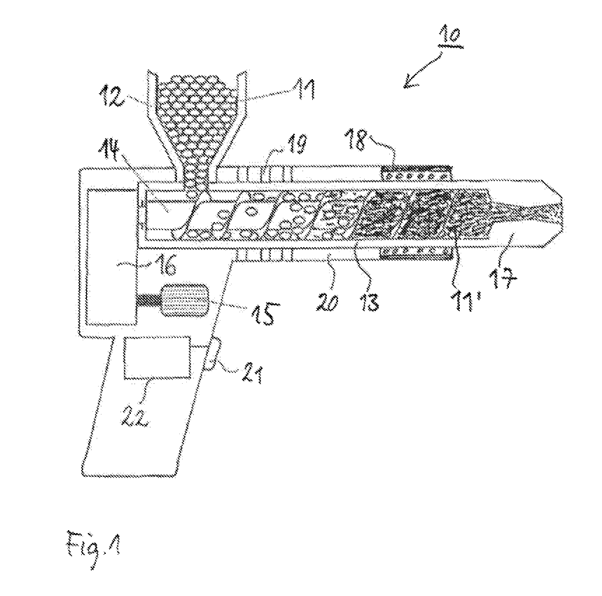

FIG. 1 is a schematic representation with partial longitudinal section of a portable extruder for producing a foam element, for example, an elongate foam strand which can be used, in particular, for purposes of thermal and/or acoustic insulation. The figure is intended only to illustrate important functions of such an apparatus and not to represent a construction that can be realized in practice.

Foamable material 11 in granule form is poured into a funnel 12 of the portable extruder 10, through which it then reaches the interior of the extruder. The foamable material is conveyed in a cylinder 13 in the direction of a nozzle 17 by means of a screw 14 operated by a motor 15 via a gear unit 16. By means of an appropriate geometric configuration of the screw 14 and of the screw cylinder 13, high pressures and shearing forces are generated in a controlled manner in the process, which result in a softening and an activation of the originally solid granules, and an additionally provided heating device 18 promotes this process. For this purpose, the geometric configuration can be optimally adapted, for example, with regard to the number and the pitch of the turns, and with regard to the distance between two adjacent turns of the screw 14, and with regard to the length and the diameter of the screw cylinder 13, and these characteristics can be matched to one another. At the nozzle 17, the activated foamable material 11′ is discharged with rapid expansion controlled by a specific temperature profile over the conveyance path of the granules or activated material and by a specific geometric configuration of the nozzle.

The appropriate temperature profile, which is essential for the operation of the portable extruder 10, over the conveyance path of the granules and the longitudinal extent of the screw 14, is ensured, on the one hand, by an appropriate positioning and electrical dimensioning of the heating device 18. On the other hand, openings 19 for local cooling are incorporated in the apparatus housing 20 of the extruder near the filling funnel 12. The openings 19 merely stand symbolically for any suitable cooling devices; it is also possible to provide, instead, ribbing of the screw cylinder 13 and/or a blower. A switching control unit 22 connected to an actuation device 21 in the handle area of the extruder housing 20 (a feature which is not shown in the figure) is connected both to the motor 15 of the screw 13 and to the heating device 18, and enables, in addition to the switching on and off of the extruder, a setting of the screw speed and heat output and thereby the setting of process parameters adapted to the material 11 used and to the conditions of use.

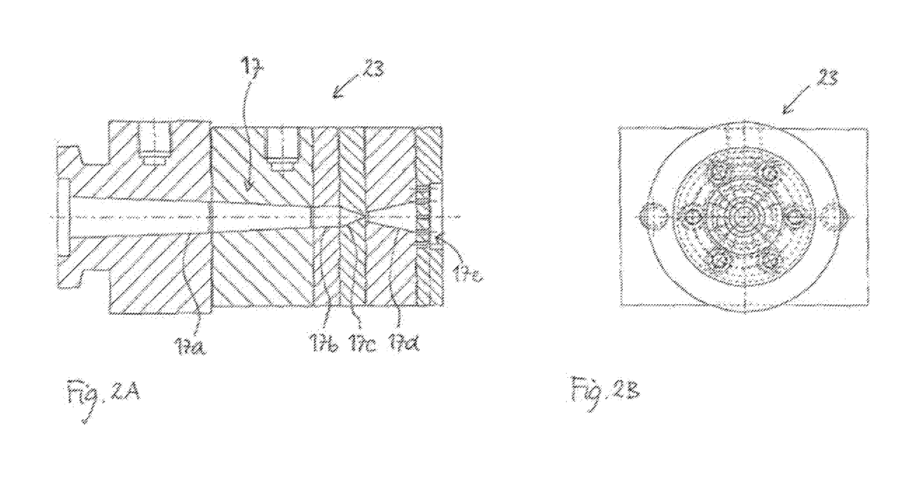

FIGS. 2A and 2B show a specific nozzle design of the portable extruder according to the invention, which is implemented as a part 23 to be inserted at the extruder outlet. To the extent applicable, reference is made here to parts shown in FIG. 1, which are designated with the reference numerals according to FIG. 1 or reference numerals based thereon.

In FIG. 2A, it is apparent that the nozzle arrangement has a first nozzle section 17a of great length, in which the nozzle cross section becomes continuously smaller with low slope, a second nozzle section 17b of small length in which the cross section remains constant, a third nozzle section 17c of small length in which the nozzle section decreases with large slope, a fourth nozzle section 17d of medium length in which the nozzle section increases with medium slope, and a fifth nozzle section 17e having a plurality of spray openings. Moreover, it is apparent that, for the implementation of these nozzle sections, the added part 23 is subdivided into a plurality of individual plates (not designated separately), wherein the first nozzle section 17a is produced by two plates or base elements joined to one another in the longitudinal direction. As a result of this modular design, it is relatively easy to produce variations of the nozzle geometry in certain sections, without having to manufacture a new added part as a whole.

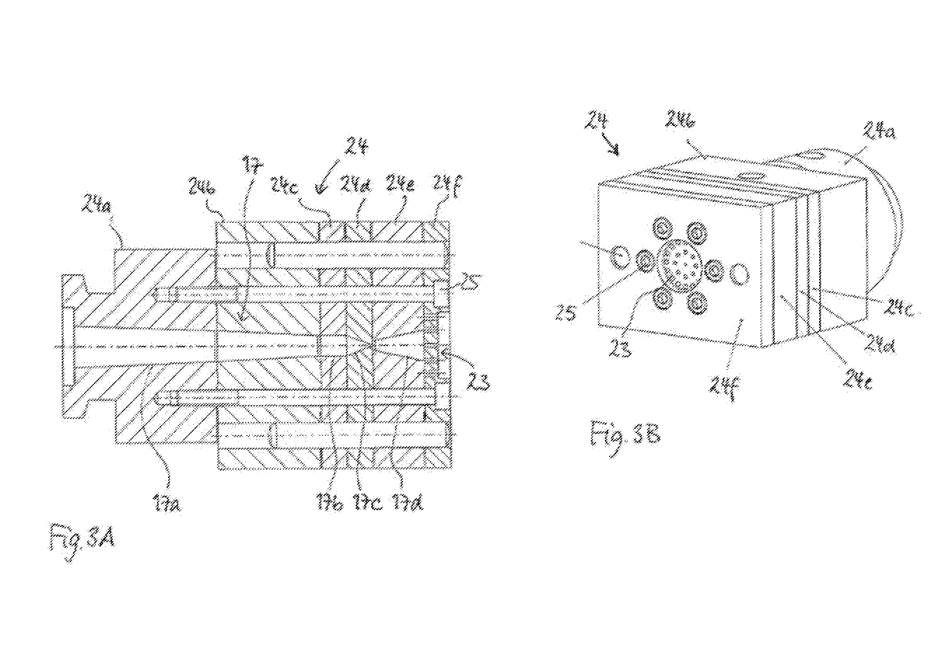

FIGS. 3A and 3B, in contrast to the above-described embodiment, show a modified nozzle part 24, which is constructed as a construction embodiment of the portable extruder 10 according to FIG. 1. By means of this nozzle part, in principle, the same geometry of the nozzle arrangement 17 as in FIG. 2A is produced, so that the nozzle sections are designated with the same reference numerals as used therein. In FIGS. 3a and 3B, the modules of which the nozzle part 24 is composed are designated with the numerals 24a to 24f, and the fastening bolts 25 for fastening the modules are also designated.

One means of implementing the invention is a foamable composition, which comprises at least one base polymer, at least one propellant and/or at least one heat stabilizer, as well as, optionally, a lubricant and a filler and, if applicable, a nucleation agent. The base polymer content here should preferably be at least 50% by weight. In order to ensure sufficient foaming, a propellant content in the range from 5 to 20% by weight has been shown to be advantageous. The lubricant and/or the heat stabilizer contents in the foamable composition preferably amount to 0.1 to 5% by weight relative to said foamable composition. With such a composition, it is possible to form polymer foams having a heat conductivity of <0.04 W/(mK) and an expansion of ≧1000%.

As base polymer of the foamable composition, which can be used for the present invention and, in particular, for the production of cores of plastic profile sections, it is possible, in principle, to use any material that can be caused to foam in a controlled manner, and that has sufficient insulation properties in the expanded state.

The base polymer is preferably an organic polymer having a melting point in the range from 20 to 400° C. The base polymer should advantageously plasticize at a temperature that is below the foaming temperature, allowing it to be deformed during the foaming process. Once the foaming temperature has been reached, the base polymer foams. It is particularly preferable for the base polymer to have a melting point in the range of 60-200° C. Moreover, the crosslinking process should preferably start only once the foaming temperature has been exceeded and the foaming has been at least partially completed.

The person skilled in the art is readily familiar with suitable base polymers. It is particularly preferable to select the base polymer in the context of the present invention from the group comprising EVA, polyolefin, polyvinyl chloride or XPS (crosslinked polystyrene). Preferred polyolefins are polymers based on ethylene or propylene, of which polyethylene, particularly in the form of LDPE (low density polyethylene), is particularly preferable. Mixtures of the aforementioned polymers can also be used as base polymer in the context of the invention.

So-called bioplastics can also be used in the context of the invention, for example, polylactides (polylactide acid, PLA), conventional starch-based mixtures or glycan. Also usable are heat curing epoxy resins (solid or liquid epoxy resins) in combination with chemical or physical propellants (see further below).

As a rule, the base polymer represents the main component of the foamable composition, wherein its proportion in the composition is preferably at least 50% by weight. The base polymer content is preferably in the range from 65 to 95% by weight, in particular in the range from 70 to 90% by weight, and most preferably in the range from 75 to 85% by weight.

Moreover, the foamable composition typically contains a chemical or physical propellant. Chemical propellants are organic or inorganic compounds, which decompose under the influence of temperature, moisture and/or electromagnetic radiation, wherein at least one of the degradation products is a gas. As physical propellants, it is possible to use, for example, compounds that transition at elevated temperature into the gaseous phase, such as pentane, butane, carbon dioxide, nitrogen or Expancel.

In the context of the present invention it has been shown to be particularly advantageous, if the foamable composition is thermally foamable and foams at a temperature of 250° C., in particular from 100° C. to 230° C., preferably from 140 to 200° C., wherein chemical propellants are used. As chemical propellants, it has been shown to be particularly advantageous to use azodicarbonamides, sulfonyl hydrazides, hydrogen carbonates or carbonates. Suitable sulfonyl hydrazides are p-toluene sulfonyl hydrazide, benzene sulfonyl hydrazide and p,p′-oxybisbenzene sulfonyl hydrazide. Sodium hydrogen carbonate is a suitable hydrogen carbonate. A particularly preferable propellant is p,p′-oxybisbenzene sulfonyl hydrazide. Suitable propellants are also commercially available under the trade names Expancel® from the company Akzo Nobel, The Netherlands, under the trade name Celogen® from the company Chemtura Corp., USA, or under the trade name Unicell® from the company Tramaco, Germany.

The heat required for the foaming can, in addition to the above-mentioned external heat sources, also be conveyed at least partially by means of internal heat sources, such as an exothermic reaction.

With regard to the propellant content, the present invention is not subject to any relevant restrictions. However, it has been shown to be advantageous if the propellant content in the foamable composition is from 5 to 20% by weight, in particular from 10 to 18% by weight, and particularly preferably in the range from 12 to 16% by weight relative to said foamable composition. In cases in which a lower expansion of the composition is desired, the content can also be lower, in particular in the range from 5 to 10% by weight.

The foamable composition from which the polymer foam can be produced optionally contains, as mentioned above, a lubricant and/or a heat stabilizer. In one preferred embodiment, the foamable composition contains a component, which has the properties of both a lubricant and a heat stabilizer. In this case, it is possible to dispense with the use of an additional lubricant or heat stabilizer component.

As heat stabilizers that simultaneously act as a lubricant in the foamable composition, fatty acid amides, fatty acids and fatty acid alcohol esters have been shown to be particularly suitable, the long aliphatic carbon chains of which impart the desired lubricant effect. At the same time, these compounds function as a heat stabilizer. It has been found particularly advantageous to use fatty acid amides, fatty acids and fatty acid alcohol esters that have a chain length of the portion based on the fatty acid or the fatty acid alcohol in the range from 6 to 24, preferably 8 to 16, and in particular 10 to 14 carbon atoms.

In the context of the invention, heat stabilizers that have a thioether function, in addition to a linear aliphatic chain, have been shown to be particularly suitable. As heat stabilizers, it is most preferable to use fatty acid alcohol diesters in which a thioether function is present in the acid portion, in particular didodecyl 3,3′-thiodipropionate.

The heat stabilizers should be present in the composition at least in an amount at which a significant stabilization of the composition after the foaming is observed, that is to say, the foam does not undergo a significant decrease in volume (10% or more) even after extended exposure (10 minutes or more) to high temperatures (150° C. or more). In particular, in the context of the present invention, a heat stabilizer content and/or lubricant content in the range from 0.1 to 5% by weight and preferably in the range from 0.5 to 3% by weight relative to the total foamable composition has been shown to be suitable. In the case of contents of less than 0.1% by weight, the quantity of the heat stabilizer is not sufficient to stabilize the foam sufficiently, whereas in the case of contents of more than 5% by weight a significant decrease in the foam volume is also observed during longer exposure of the foam to high temperatures.

Moreover, it has been shown to be advantageous if the foamable composition is stabilized and strengthened during the foaming. This can be ensured by adding crosslinking agents, which are preferably activated by degradation products of the propellant and trigger a crosslinking of the foam produced. Here, the crosslinking of the foamable composition should start only at a temperature equal to or above its foaming temperature, since, otherwise, the crosslinking of the foamable composition occurs before its foaming has been completed and, as a result, it would be impossible to guarantee that the foamable composition before crosslinking fills in, for example, a hollow space and that the foam has a compact structure.

With regard to the crosslinking of the polymer foam obtained, the present invention is also not subject to any relevant restrictions. A crosslinking of the foam is possible, in particular, with the aid of crosslinking agents that do not react with the base polymer, such as, for example, epoxy-based crosslinking agents, or with the aid of crosslinked that react with the base polymers. Peroxide crosslinking agents are an example of such crosslinking agents. In the context of the present invention, crosslinking with peroxide crosslinking agents or crosslinking with epoxies is preferable.

In crosslinking with peroxides, it is possible to use conventional organic peroxides such as, for example, dibenzoyl peroxide, dicumyl peroxide, 2,5-di-(t-butylperoxyl)-2,5-dimethylhexane, t-butyl cumyl peroxide, α,α′-bis(t-butylperoxy)diisopropylbenzene isomer mixture, di-(t-amyl) peroxide, di-(t-butyl) peroxides, 2,5-di-(t-butylperoxy)-2,5-dimethyl-3-hexine, 1,1-di(t-butylperoxy)-3,3,5-trimethylcyclohexane, n-butyl 4,4-di-(t-butylperoxy)valerate, ethyl 3,3-di-(t-amylperoxy)butanoate, or t-butyl peroxy-3,5,5-trimethylhexanoate. Dicumyl peroxide is a preferred peroxide.

When using epoxy-based crosslinking agents, a mixture of an epoxy-containing polymer and of a polymer containing maleic acid anhydride groups has been shown to be particularly advantageous. The epoxy-containing polymer is preferably a copolymer made of ethylene and glycidyl methacrylate with a content of glycidyl monomer in the range from 4 to 12% by weight. The polymer containing maleic acid anhydride groups consists preferably of a terpolymer made of ethylene, an acrylic acid alkylester, in particular, based on an alkyl alcohol having 2 to 10 carbon atoms, and maleic acid anhydride. The content of maleic acid anhydride in the terpolymer is preferably in the range from 1.5 to 5%. It is particularly preferable if these two crosslinking agent components are present in a ratio from 2:1 to 1:2, in particular approximately in a ratio of 1:1.

This polymer combination was shown to be particularly advantageous in combination with propellants, during the heating of which water or alcohol is released, since the maleic acid anhydride groups can be hydrolyzed to maleic acid by the water or alcohol formed and, in turn, enter into a reaction with the epoxy groups of the epoxy-containing polymer and produce a crosslinking.

In the foamable composition, the crosslinking agent content is preferably from 1 to 25% by weight, particularly in the range from 2 to 18% by weight, and particularly preferably in the range from 2 to 10% by weight relative to the total foamable composition. If a peroxide is included as crosslinking agent, then its concentration can, however, also be lower, in particular in the range from 1 to 5% by weight and particularly preferably in the range from 1 to 2% by weight.

In an another preferred embodiment, the foamable composition is free of crosslinking agents.

Moreover, it has been shown to be advantageous if, in addition, at least one heat reflector, at least one heat loss additive, at least one anticondensation additive, at least one antioxidant, urea and/or at least one filler are included in the foamable composition. Graphite, carbon black and/or titanium dioxide represent advantageous heat reflectors. Fillers that are to be included advantageously in the polymer foam are calcium carbonate or talc, the content of which in the polymer foam can be from 0.5 to 8% by weight, particularly 1 to 5% by weight, and particularly preferably, in an amount of approximately 2% by weight. Fillers can be added, for example, as nucleation agents, in order to improve the foaming. Suitable antioxidants are sterically hindered phenols, for example.

The implementation of the invention is not limited to the above-explained examples and aspects; instead, implementation is possible in numerous variations that fall within the practice of the person skilled in the art.

### LIST OF REFERENCE NUMERALS

10=Portable extruder
11=Starting material (granules)
11′=Activated material
12=Funnel
13=Screw cylinder
14=Conveyor screw
15=Motor
16=Gear unit
17=Nozzle
17a to 17e=Nozzle sections
18=Heating device
19=Openings
20=Extruder housing
21=Actuation device
22=Switching control unit
23=Added part
24=Nozzle part
24a to 24f=Modules of the nozzle part
25=Fastening bolts

1. A method for producing a foam element, wherein an expandable starting material of the foam is supplied as a granulated material to a portable extruder, activated or fused in the latter under pressure and by heating, and expanded to form the foam element during the manually controlled discharge from said portable extruder.

2. The method according to claim 1, wherein a portable extruder having at least one conveyor screw is used, and said portable extruder is configured in such a manner, and the mechanical properties of the starting material are predetermined in such a manner, that shearing forces occur which at least contribute to a thermal activation of the starting material.

3. The method according to claim 1, wherein a portable extruder having a heating device is used, and the heating device is operated in such a manner that it at least contributes to a thermal activation of the starting material.

4. The method according to claim 1, wherein the expandable granular starting material contains a physical propellant.

5. The method according to claim 1, wherein, in addition to the expandable granular starting material which contains, in particular, a solid or liquid epoxy resin, a curing agent, in particular, in powder or pellet form, is used.

6. The method according to claim 1, wherein the expansion process of the starting material when discharged from the portable extruder is controlled by means of a nozzle geometry which is adapted to the application and tailored to an insulation material or its starting material, in particular, in an additional part attached on the outlet side of the portable extruder.

7. The method according to claim 1, wherein it is provided that the starting material passes through several temperature zones in the portable extruder, specifically, through a first zone of relatively low temperature, in order to prevent premature expansion and/or bonding of the granulated material, then through a second zone of higher temperature, for activating or for fusing the material, and finally through a nozzle section, which is relatively cool compared to the second zone.

8. The method according to claim 1, wherein a sensor-based temperature monitoring of the starting material or of foam produced is carried out in the portable extruder, optionally coupled with an automatic readjustment of the temperature.

9. The method according to claim 1, wherein a pressure monitoring is provided in the outlet area or the area near the outlet of the portable extruder, optionally coupled with an automatic readjustment or manual updating of at least one process parameter.

10. A portable foam extruder for performing the method according to claim 1, having at least one conveyor screw, the screw geometry of which is configured in accordance with the screw cylinder for generating high shearing forces in a conveyed starting material of a foam and/or with a heating device for heating the starting material.

11. The portable foam extruder according to claim 10, having a nozzle arrangement provided on the outlet side, in particular, in an additional part put on the outlet side, where said nozzle arrangement is configured for the expansion of a preactivated starting material having a high volume expansion gradient.

12. The portable foam extruder according to claim 11, wherein the nozzle arrangement has at least one first nozzle section, in which the nozzle cross section becomes smaller with a small slope or remains constant, and a second nozzle section of small length in which the nozzle cross section decreases with a large slope.

13. The portable foam extruder according to any claim 10, having a shaping tool on the outlet-side for the final shaping of the foam element produced.

14. The portable foam extruder according to any claim 10, having means for implementing a predetermined temperature profile, which comprise, in particular, a heating or cooling device for forming a first zone of relatively low temperature near the intake area, a heating device for forming a second zone having a higher temperature downstream of the first zone, and means for forming a third zone of lower or equal temperature downstream of the second zone.

15. The portable foam extruder according to claim 10, which comprises a temperature sensor for measuring the temperature of the material in the portable extruder and/or a pressure sensor for measuring the pressure at a suitable location on the material flow path near the outlet.

16. Use of a portable extruder according to claim 10 for producing foam.
